(19) United States
(12) Patent Application Publication
(10) Pub. No.: US 2014/0061206 A1
(43) Pub. Date: Mar. 6, 2014

(54) CONTROLLED EMPTYING KITCHEN SAUCEPAN

(71) Applicants: Daniele Lagostina, Pavia (IT); Andrea Catellono, Cusagon(MI) (IT); Marco Chendi, Milano (IT)

(72) Inventors: Daniele Lagostina, Pavia (IT); Andrea Catellono, Cusagon(MI) (IT); Marco Chendi, Milano (IT)

(73) Assignee: DINAMICA S.R.L., MILANO (IT)

(21) Appl. No.: 14/115,323

(22) PCT Filed: May 2, 2012
(86) PCT No.: PCT/IB2012/000865

§ 371 Date: Nov. 1, 2013

(30) Foreign Application Priority Data
May 3, 2011 (IT) MI2011A000737

(51) Int. Cl. A47J 36/20

(52) U.S. Cl. CPC A47J 36/20
USPC 220/573.4

(57) ABSTRACT

A controlled emptying kitchen saucepan, characterized in that said saucepan comprises a saucepan body having a peripheral wall and a top rim for housing a cover therein, said saucepan body including a perforated bottom and an inner double-bottom which can be raised with respect to said perforated bottom to allow water to be discharged, said saucepan including moreover a bistable driving mechanism for driving said double-bottom which is supported by a perforated grid, said grid also operating for holding the cooked food article as water is discharged, said cover including a cover knob the shape of which is functionally correlated to the double-bottom driving mechanism and forming a saucepan bearing base as water is discharged therefrom, said cover comprising three or more supporting elements made of a deformable material for stabilizing the saucepan as water is discharged therefrom.

### BACKGROUND OF THE INVENTION

The present invention relates to a controlled emptying kitchen saucepan.

Saucepans designed for cooking pasta and having a perforated cover there-through it is possible to drain water at the end of the pasta cooking are already known.

However, those prior saucepans are affected by a lot of serious drawbacks.

At first, they do not allow to eliminate the unnatural movement of the user arms and wrists necessary for upturning the saucepan, thereby great is a risk of un-controllably pouring boiling water.

Moreover, the draining operation is difficult since steam and water exit the saucepan at a position very close to the saucepan user hands.

Moreover, if the saucepan body does not comprise proper clamping systems, the user must compulsorily restrain it during the water draining operation, with self evident further risks.

Yet another drawback is that perforated over increases the water boiling time.

### SUMMARY OF THE INVENTION

Accordingly, the aim of the present invention is to provide a controlled emptying kitchen saucepan allowing to drain cooking water by a very simple and safe draining operation.

Within the scope of the above mentioned aim, a main object of the invention is to provide such a controlled emptying kitchen saucepan which is very efficient in cooking operations while being simple to use and clean.

Another object of the present invention is to provide such a controlled emptying kitchen saucepan having a strong and operatively reliable construction.

Yet another object of the present invention is to provide such a controlled emptying kitchen saucepan which may be easily made starting from commercially available elements and materials and which, moreover, is very competitive from a mere economic standpoint.

Yet another object of the present invention is to provide such a controlled emptying kitchen saucepan which, owing to its specifically designed structural features, is very reliable and safe in operation.

According to one aspect of the present invention, the above mentioned aim and objects, as well as further objects which will become more apparent hereinafter, are achieved by a controlled emptying kitchen saucepan, characterized in that said saucepan comprises a saucepan body having a peripheral wall and a top rim for housing a cover therein.

Said saucepan body includes a perforated bottom and an inner double-bottom, which can be raised with respect to said perforated bottom to allow water to be discharged.

Said saucepan includes moreover a bistable driving, mechanism, for driving said double-bottom which is supported by a perforated grid.

Said perforated grid further achieves two very important and different aims:

A) a clamping by a bayonet clamping system, or a like system, of the overall saucepan mechanism to the saucepan body;

B) holding of the cooked food article, as the cooking water is discharged.

The cover comprises a cover knob the shape of which is functionally related to the double-bottom driving mechanism and forming a saucepan hearing base as water is discharged therefrom.

### BRIEF DESCRIPTION OF THE DRAWINGS

Further characteristics and advantages of the present invention will become more apparent hereinafter from the following detailed disclosure of a preferred, though not exclusive, embodiment of the invention which is illustrated by way of an indicative but not limitative example in the accompanying drawings, where:

FIG. 1 is an exploded perspective view of the controlled emptying kitchen saucepan, according to the present invention;

FIG. 2 is a further perspective view, enlarged with respect to Figure showing in a detailed manner a bistable mechanism for driving the saucepan double-bottom;

FIG. 3 is a further perspective view shown the saucepan with the sauce-pan cover in a closed cooking position;

FIG. 4 is yet a further perspective view, similar to FIG. 3, but showing the saucepan cover in a raised condition for allowing steam to partially exit the sauce-pan during the cooking operation; and

FIGS. 5-11 are side elevation views showing an operative sequence for discharging or draining the cooking water, according to the present invention.

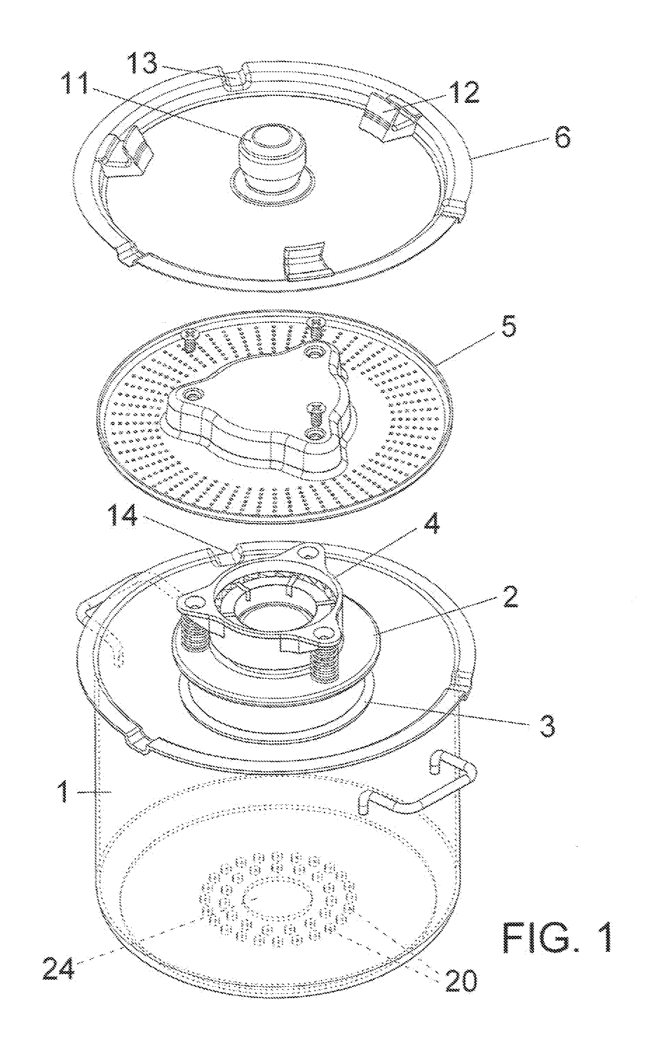

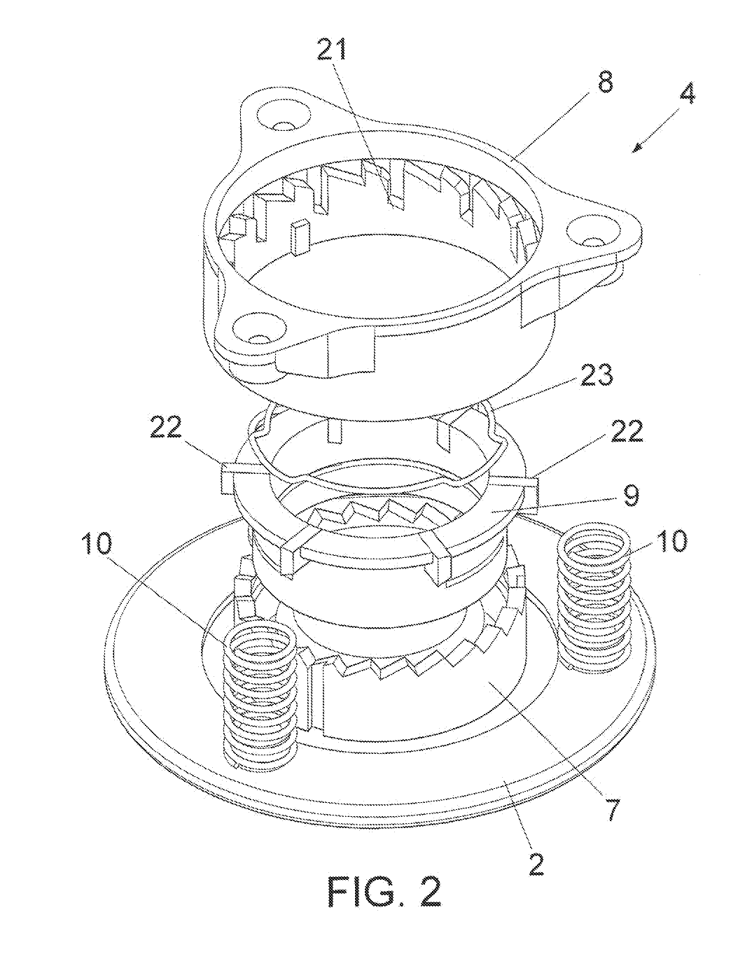

### DESCRIPTION OF THE PREFERRED EMBODIMENTS

With reference to the number references of the above mentioned figures, the controlled emptying kitchen saucepan, according to the present invention, comprises a saucepan body 1 having a peripheral wall and a top rim, so contoured as to house a saucepan cover 6 therein.

The saucepan body comprises a perforated bottom 20 and an inner double-bottom 2, which may be raised from the perforated bottom 20 to allow water to be discharged.

The sealing or tightness relationship between the saucepan cotton 20 an double-bottom 2 is assured by one or more sealing gaskets 3.

The inventive saucepan comprises moreover a bistable driving mechanism 4 for driving said double-bottom 2.

A perforated grid 5 allows the bistable mechanism 4 to be properly supported and said perforated grid 5 also operates for restraining or holding the cooked food article, as water is discharged.

Said perforated grid 5 is firmly coupled to the bistable mechanism 4 through coupling or clamping elements such as screws, rivets or the like.

The perforated grid 5 is moreover firmly coupled to the saucepan body 1 by a bayonet coupling or the like allowing the overall perforated grid+mechanism+double-bottom assembly to be separated from the saucepan body.

The cover 6 comprises a cover knob 11 the shape of which is functionally correlated to the double bottom driving mechanism.

The saucepan cover 6 comprises a perimetrical cover edge including bearing 12 and abutment 13 elements.

The abutment elements 13 engage, if required, in suitable engaging recesses 14 or the saucepan edge or rim.

The opening/closing bistable mechanism 4 comprises three suitably contoured concentric ring elements.

A first ring element 7 has a rack top profile and is firmly coupled to or rigid with the double-bottom 2.

A second ring element 8, arranged outside of the first ring element 7, is rigid with the perforated grid 5 and accordingly with the saucepan body 1.

The inner surface of the second ring element 8 includes a plurality of cyclic ridges 21 forming a continuous path.

Said first and second ring elements 7 and 8 are so constructed as to slide within each other without rotating.

A third ring element 9, arranged inside said first and second ring elements, is connected to the fast ring element 7 by a metal clamp element 23 or other connecting system so as to allow a rotary movement about a central axis and a limited mutual translation along that same axis.

Said third ring element 9 comprises a plurality of radially extending ridges 22 which slidably contact the cyclic ridges 21 of the second ring element 8.

Accordingly, the above disclosed clamping elements allow the third ring element 9 to be driven with a rotary-translating movement controlled both by the first ring element 7 and the second ring element 8.

The ridge path 21 of the second ring element 8, including its slanted working surfaces, provides, in addition to a rotary movement of said ring element 9, alternately varying top opening stroke and bottom dosing stroke limit positions for said third ring element and accordingly of said first ring element 7 coupled thereto.

Thus, said third ring element 9, by rotating, alternately assumes a top and bottom positions, whereas the first ring element 7 does not rotate but is only raised and lowered, so as to cause said double-bottom 2 to be alternately raised and lowered thereby providing opening and closing positions in a continuous endless succession.

The bistable mechanism 4 is held under tension by three or more spring elements 10 operating for loading the sealing gasket 3, the grid+driving mechanism+double-bottom+spring assembly being mounted with a set preloading of said springs even with the saucepan in a dosed condition thereof.

In the meantime, said springs 10 further operate for providing said driving mechanism with a driving force in a return operating step thereof, whereas, in the direct operating step thereof, the driving force is supplied by a pressure applied by a user to the saucepan handles, so as to overcome the spring 10 biasing.

The operation of the controlled emptying kitchen saucepan is very simple and per se evident.

More specifically, starting from a lowered double bottom 2 position, that is in a dosed saucepan condition, the saucepan is filled with water and a desired food article is cooked as desired.

To that end it would e advantageous to use the dedicated cover, which is anyhow essential to operate the double-bottom, as it will be disclosed in a more detailed manner hereinafter.

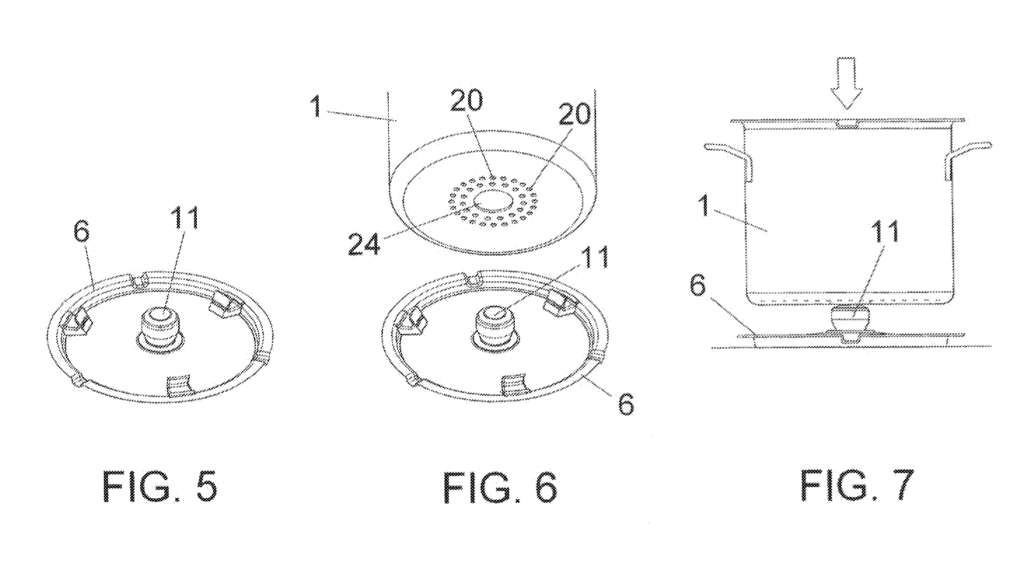

At the end of the cooking operation, or before ending the cooking if desired, the saucepan cover 6 is caused to bear on a bottom of the washbasin, preferably of a flat base or bottom type, and with the cover knob 6 upward directed, as shown in FIG. 5.

Then, the saucepan is gripped through its handles, as usual, and is caused to bear on the cover 6 while engaging the cover knob 11 in a suitable engaging recess 24 formed on the saucepan bottom 20 and double-bottom 2.

A resilient supporting element 12 system, suitably arranged on the cover 6, makes the saucepan stable while facilitating its operation which, in any case, will become natural after few operating tests, as shown in FIGS. 6 and 7.

At this time, it will be sufficient to deeply and evenly press downward hot the saucepan handles, thereby, by operating the saucepan mechanism, it will start to discharge water.

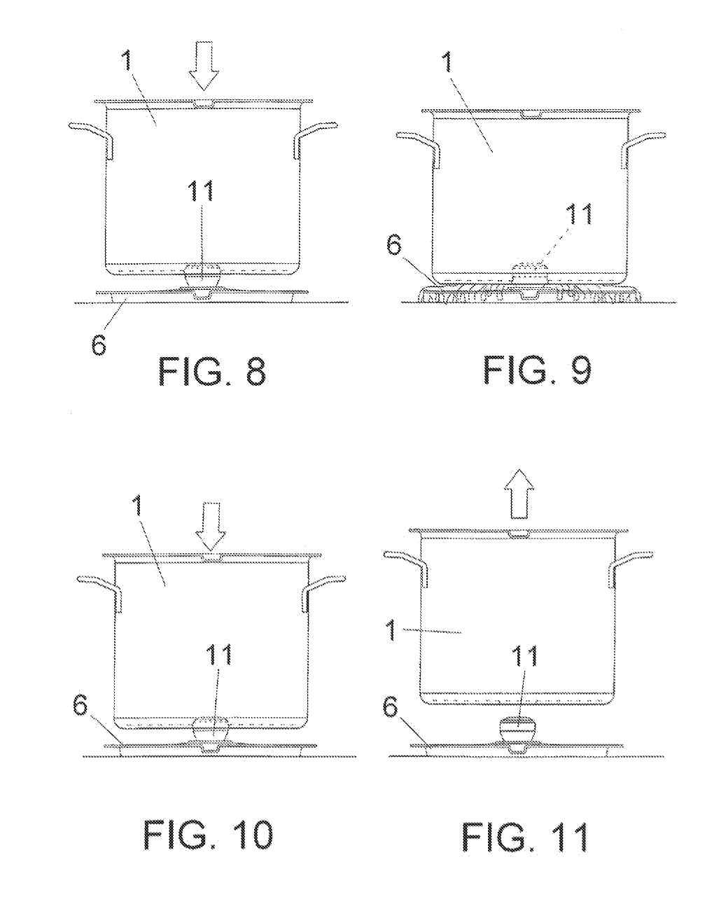

By releasing the handles, the mechanism will be locked in its open position, As shown in FIGS. 8 and 9.

A further deep pressing on the handles and a subsequent releasing thereof will operate the mechanism again, thereby, causing the saucepan to be dosed,

Then, the closed saucepan may be removed from the washbasin in a safe manner, as shown in FIGS. 10 and 11.

A suitable warning element will signal, in an easily visible manner to the operator, the closed or open condition of the mechanism.

In this connection it should be pointed out that the system is very safe Per se since the raising of the double-bottom that is the saucepan opening, occurs in an inward direction, and through the cover knob.

Otherwise, the mechanism cannot be operated and the double-bottom will not be raised.

Moreover, the water inside will press the double-bottom against the sauce pan bottom, thereby improving the gasket sealing.

To sum up, the operation is started from the dosed position, that is with the mechanism in an extended position, and the ring elements 9 and 7, and consequently the double-bottom 2, in a lowered position.

By pressing the saucepan handles, the double-bottom will be caused to raise, pushed by the cover knob, and the first ring element 7 will be also raised to cause a rotary movement of the third ring element 9 the ridges of which will occupy a new position on the second ring element 8 path.

As pressure is released, the springs will downward push the third ring element 9 which, however, is compelled to follow its path on the second ring element B.

The result will be a further rotation of the third ring element 9 and a slight lowering thereof, up to achieve a stable position, in the opening condition.

By pressing again on the handles, an analogous operation will occur, but in the releasing step the path on the second ring element 8 will cause the third ring element 9 to reach a lowered end position which is the same starting one.

The operating cycle may be now restarted again.

As mentioned above, the perforated grid+mechanism+double-bottomm+spring assembly is so designed as to always remain in an assembled condition and to form a stand-alone body, which may be easily detached from the saucepan body through a bayonet coupling or the like.

This allows the saucepan to be easily cleaned: in fact, suitable perforations of the individual components will allow the saucepan to be washed both manually and in a dishwashing machine.

As disclosed above, besides providing a conventional heat holding function, the cover is also indispensable for the operation of the overall system and is accordingly an integrating part of the latter.

As stated, the cover 6 comprises the cover knob 11 having such a shape and size as to drive the mechanism and to make as natural as possible its engagement with the saucepan bottom and double-bottom.

The cover comprises, moreover, a set of three or more bearing elements 12, preferably made of a deformable material such as silicone or the like, for perfectly stabilizing the saucepan as it is released on surface for discharging water.

Moreover, said cover has advantageous features also in carrying out its conventional cover function.

In fact, the over 6 composes a plurality of ridges 13 which, depending on the position of the cover, may engage with corresponding recesses 14 on the saucepan rim.

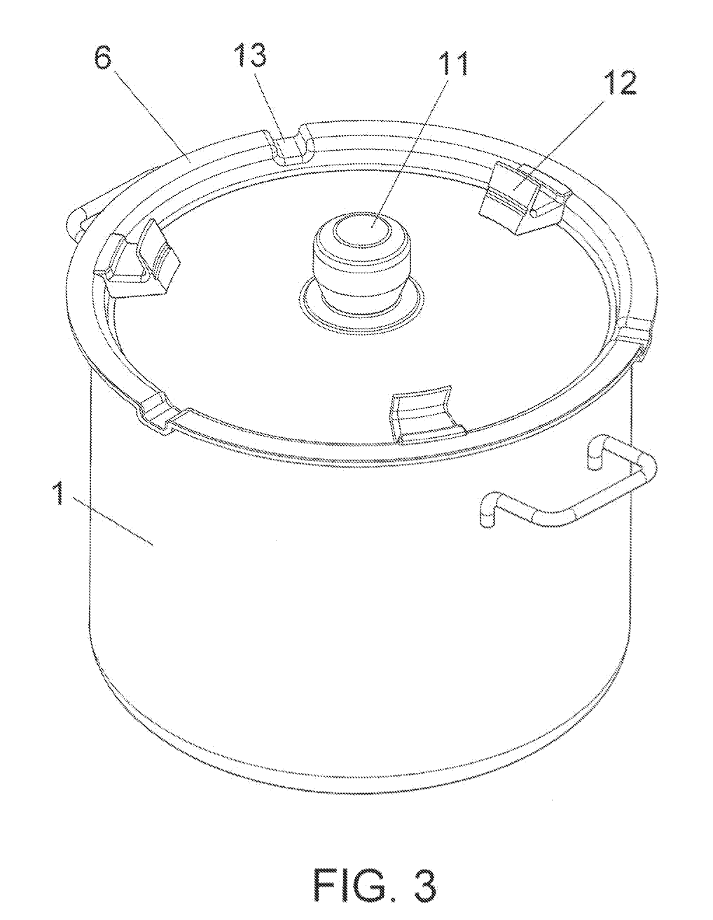

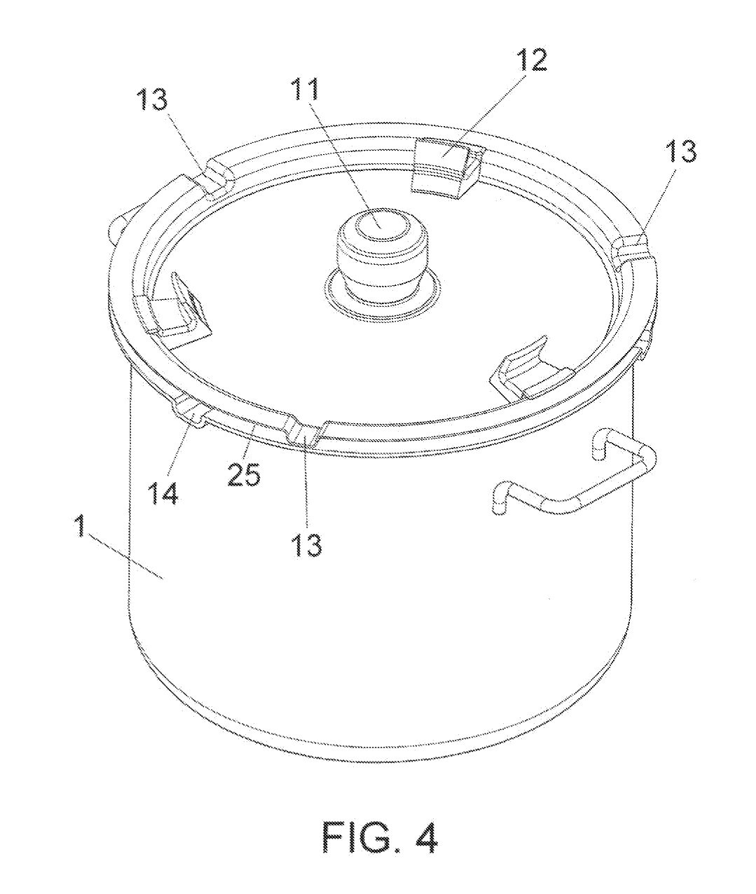

As said ridges or projections and recesses are mutually mated (FIG. 3), the cover is held in contact with all the saucepan rim at a lowered position, thereby speeding up the heating of water whereas, as said ridges or projections are so arranged as not to mate with their recesses, the cover will bear only on the ridges 13 and accordingly will be raised from the saucepan rim, as shown in FIG. 4, thereby providing an annular skit 25, of a set height, allowing steam to partially exit, to drastically reduce any water overflows during a boiling operating step and thereby further reducing a flame switching off risk.

Said ridges 13, together with the bearing elements 12, may be replaced with a single component designed for carrying out both said functions.

It has been found that the invention fully achieves the intended aim and objects.

In fact, the invention has provided a controlled emptying kitchen saucepan allowing to drain, by a very simple and easy draining operation, the cooking water.

The double-bottom system, being driven by a bistable mechanism and a specifically designed cover, also allows to perform in a very safe manner the water discharging operation.

The main food article for which the subject saucepan has been designed is, as stated, pasta, in any of its forms, but it should be apparent that the saucepan according to the present invention is also suitable for cooking and draining any other type of food articles such as vegetables, meats, and so on.

In practicing the invention, the used materials as well as the contingent size and shapes can be any, according to requirements.

1. A controlled emptying kitchen saucepan, characterized in that said saucepan comprises a saucepan body having a peripheral wall and a top rim for housing a cover therein, said saucepan body including a perforated bottom and an inner double-bottom which can be raised with respect to said perforated bottom to allow water to be discharged, said saucepan including moreover a bistable driving mechanism for driving said double-bottom which is supported by a perforated grid, said grid also operating for holding the cooked food article as water is discharged, said cover including a cover knob the shape of which is functionally correlated to the double-bottom driving mechanism and forming a saucepan bearing base as water is discharged therefrom, said cover comprising three or more supporting elements made of a deformable material for stabilizing the saucepan as water is discharged therefrom.

2. A controlled emptying saucepan, according to claim 1, characterized in that said grid is rigidly coupled to the saucepan body by a bayonet coupling assembly or the like allowing the perforated grid+driving mechanism+double-bottom assembly to be separated from the saucepan body.

3. A controlled emptying saucepan, according to claim 1, characterized in that said saucepan comprises one or more gaskets for tightly coupling said saucepan bottom and double-bottom.

4. A controlled emptying saucepan, according to claim 1 , characterized in that said bistable opening/closing driving mechanism comprises three contoured concentric ring elements, a first ring element having a top rack contour and being rigid with said double-bottom; a second ring element, arranged outside of said first ring element, being rigid with the perforated grid and saucepan body; said second ring element having an inner surface including a plurality of cyclic ridges forming a continuous path; said first and second ring elements being so constructed as to slide within each other without rotating; a third ring element, arranged inside said first and second ring elements, being connected to the first ring element by a metal clamp element or other connecting system so as to allow a rotary movement about a central axis and a limited mutual translation along that same axis; said third ring element comprising a plurality of radially extending ridges which slidably contact the cyclic ridges of the second ring element; said third ring element being driven with a rotary-translating movement both by said first ring element and second ring element.

5. A controlled emptying saucepan, according to claim 1, characterized in that the ridge path of said second ring element, including its slanted working surfaces, provides, in addition to a rotary movement of said second ring element, alternately varying top opening stroke and bottom closing stroke limit positions for said third ring element and accordingly of said first ring element coupled thereto, thereby the third ring element, by rotating, alternately assumes a top and bottom positions, whereas the first ring element does not rotate but is only raised and lowered, so as to cause said double-bottom to be alternately raised and lowered thereby providing opening and closing positions in a continuous endless succession.

6. A controlled emptying saucepan, according to claim 1, characterized in that said bistable driving mechanism is held under tension by three or more spring elements operating for loading the sealing gasket, the grid+driving mechanism+double-bottom+spring assembly being mounted with a set preloading of said springs even with the saucepan in a closed condition thereof, said springs further operating for providing said driving mechanism with a driving force in a return operating step thereof, whereas, in the direct operating step thereof, the driving force is supplied by a pressure applied by a user to the saucepan handles, so as to overcome the spring biassing.

7. A controlled emptying saucepan, according to claim 1, characterized in that said cover comprises a plurality of ridges or projections which, depending on the cover position, are adapted to engage with corresponding recesses formed on the saucepan rim; as said ridges or projections and recesses are mutually mated, the cover being held in contact with all the saucepan rim at a lowered position, thereby speeding up the heating of water whereas, as said ridges or projections are so arranged as not to mate with their recesses, the cover will bear only on the ridges and accordingly will be raised from the saucepan rim, thereby providing an annular slot, of a set height, allowing steam to partially exit, to drastically reduce a water overflow during a boiling operating step and thereby further reducing a flame switching off risk.
